(19) United States
(12) Patent Application Publication
(10) Pub. No.: US 2004/0226309 A1
(43) Pub. Date: Nov. 18, 2004

(54) Temperature controlled, pallet-sized shipping container

(76) Inventor: Kenneth W. Broussard, Bridge City, TX (US)

Correspondence Address: BRACEWELL & PATTERSON, L.L.P., Attention: James E. Bradley, P.O. Box 61389, Houston, TX, 77208-1389, US

(21) Appl. No.: 10/780,548

(22) Filed: Feb. 17, 2004

Related U.S. Application Data
(60) Provisional application No. 60/447,987, filed on Feb. 17, 2003.

(51) Int. Cl. F25B 27/00; F25D 15/00; F25D 3/08; F17C 13/00; F25B 21/00

(52) U.S. Cl. 62/236; 62/371; 62/457.9

(57) ABSTRACT

A portable, temperature-controlled container for storing and transporting temperature-sensitive materials. The portable, temperature-controlled container includes a container having a bottom wall, four sides walls, and a top wall defining a cargo space. The container includes a temperature regulating unit connected to the container. The temperature regulating unit comprising a refrigeration unit. The temperature regulating unit being in communication with the cargo space of the container. The container includes a temperature controller connected to the container. The temperature controller comprising a temperature control unit and a temperature sensor positioned in the cargo space of the container. The container also includes a power supply. The temperature regulating unit can include a heating unit

### RELATED APPLICATIONS

This patent application claims the benefit of co-pending, provisional patent application of U.S. Ser. No. 60/______, filed on Feb. 15, 2003, and titled “TEMPERATURE CONTROLLED, PALLET-SIZED SHIPPING CONTAINER,” which is hereby incorporated by reference in its entirety.

### BACKGROUND OF THE INVENTION

1. Field of the Invention

The present invention relates generally to temperature-controlled containers, and more particularly to temperature-controlled containers that can both refrigerate and heat the cargo space, and to methods of transporting temperature-sensitive goods using such containers.

2. Background of the Invention

Goods are often shipped in containers, truck trailers, and rail cars. Pallet-sized shipping containers have been developed and sold commercially for small loads which do not require a full-size container, trailer, or rail car. Pallet-sized containers which are not temperature controlled are made by several manufacturers, including Cherry's Industrial Equipment Corporation, Bensenville, Ill.; Edge Industrial, Newport Beach, CA; Topper Industrial, Inc., Sturtevant, Wis.; and Magnum Fire and Safety Systems, Port Arthur, Tex.

Perishable and temperature-sensitive goods such as food stuffs, flowers, pharmaceuticals, and biological materials are commonly transported in refrigerated containers, rail tank and box cars, and trailers.

The transportation of temperature-sensitive cargo usually involves the use of a dedicated refrigerated container with a single temperature set point and significant power demand. The power source, such as a motor driven alternator, must remain running when the container is not moving in order to maintain the internal temperature of the container. Even if the shipment does not fill the entire trailer or container, often a whole trailer must be used because existing temperature control systems do not allow for load consolidation or multiple stops. As a result, refrigerated shipping is often 5 to 10 times the cost of a similar volume of non-refrigerated cargo.

Pallet-sized refrigerated shipping containers have also been developed. They typically provide refrigeration using liquid CO2, dry ice, or water ice with a temperature control system designed to transfer cold by conduction or convection from a cold storage compartment to a cargo compartment. Pallet-sized refrigerated shipping containers are sold by The Pallet Reefer Company, Houma, La.; and Envirotainer of Knivsta, Sweden. Some of the pallet-sized shipping containers are collapsible so that they take up less space on the return trip of the transport unit. For example, a collapsible refrigerated shipping container is described in U.S. Pat. No. 6,237,361.

While the pallet-sized shipping containers currently available meet some of the requirements of the transportation industry, they have deficiencies. The use of liquid CO2, dry ice, and water ice in these containers creates logistical challenges and operational inefficiencies. Moreover, the use of dry ice poses a potential hazard and may require hazardous material handling protocols in some circumstances. In addition, these containers are only designed to ship cargo that needs to be refrigerated. They are not capable of heating the cargo space when the ambient temperature is below the safe temperature zone of the cargo.

Thus, there is a need for a portable, temperature-controlled container for storing and transporting temperature-sensitive materials which can refrigerate and heat the cargo space.

### SUMMARY OF THE INVENTION

The present invention meets this need by providing a portable, temperature-controlled container for storing and transporting temperature-sensitive materials. The portable, temperature-controlled container includes a container having a bottom, four sides, and a top defining a cargo space. The portable, temperature-controlled container has an insulated vacuum panel positioned on an inside wall of the container. The portable, temperature-controlled container has a temperature regulating unit connected to the container. The temperature regulating unit includes a refrigeration unit and a heating unit, and is in communication with the cargo space of the container. The portable, temperature-controlled container also has a temperature controller connected to the container. The temperature controller includes a temperature control unit and a temperature sensor positioned in the cargo space of the container. The portable, temperature-controlled container also has a power supply.

The container can also be modified in numerous other ways. For example, the insulated panel is typically a vacuum panel with has an R value per inch of at least about 20. Furthermore, there is typically a plurality of insulated vacuum panels, with one of the plurality of insulated vacuum panels being positioned on the inside wall of the each of the four sides, and the top of the container. The power supply can be an AC source or a DC source, and can be internal or external. The DC source can be a battery. There can optionally be a battery charger, and/or an AC to DC converter.

The temperature regulating unit can include a fan. The refrigeration unit can be a vapor compression refrigeration unit. Typical vapor compression refrigeration units that are suitable include, but are not limited to, a DC powered rotary compressor, an AC powered rotary compressor, or an AC powered linear compressor. The portable, temperature-controlled container can include a thermal storage phase change material. The thermal storage phase change material can be in the refrigeration unit, including, but not limited to, in a fin heat exchanger having coils filled with thermal storage phase change material. Alternatively, the thermal storage phase change material can be in the cargo space.

The portable, temperature-controlled container can optionally include a computer port for downloading information to a computer. The port can include, but is not limited to an infrared computer port, or a USB port. The portable, temperature-controlled container can optionally include a global positioning satellite receiver. It can also optionally include a wireless telephone and modem.

The portable, temperature-controlled container may be made so that at least one side may be opened for access to the cargo space, if desired. The top can also be removable, if desired. The portable, temperature-controlled container typically includes at least four feet projecting downward from the bottom of the container, the feet defining an opening therebetween so that forklift tines may be inserted into the opening. The container can be made of any suitable material including, but not limited to, aluminum, or a plastic material. The container can be collapsible, if desired. In one embodiment, the four sides can be folded flat over the bottom. The cargo space is generally at least about 30 cubic feet.

### BRIEF DESCRIPTION OF THE DRAWINGS

FIG. 1 shows a perspective view of one embodiment of the temperature-controlled container of the present invention.

FIG. 2 shows a cross-section of one embodiment of a wall of the temperature-controlled container of the present invention.

FIG. 3 shows another perspective view of the embodiment of FIG. 1.

FIG. 4 shows a view of the housing on one side of the present invention.

FIG. 5 shows another perspective view of the embodiment of FIG. 1.

FIG. 6 shows a front view of an alternative embodiment of the present invention.

FIG. 7 shows an end view of the embodiment of FIG. 6.

FIG. 8 shows a perspective view of another alternative embodiment of the present invention.

FIG. 9 is a schematic of the temperature controller.

### DETAILED DESCRIPTION OF THE INVENTION

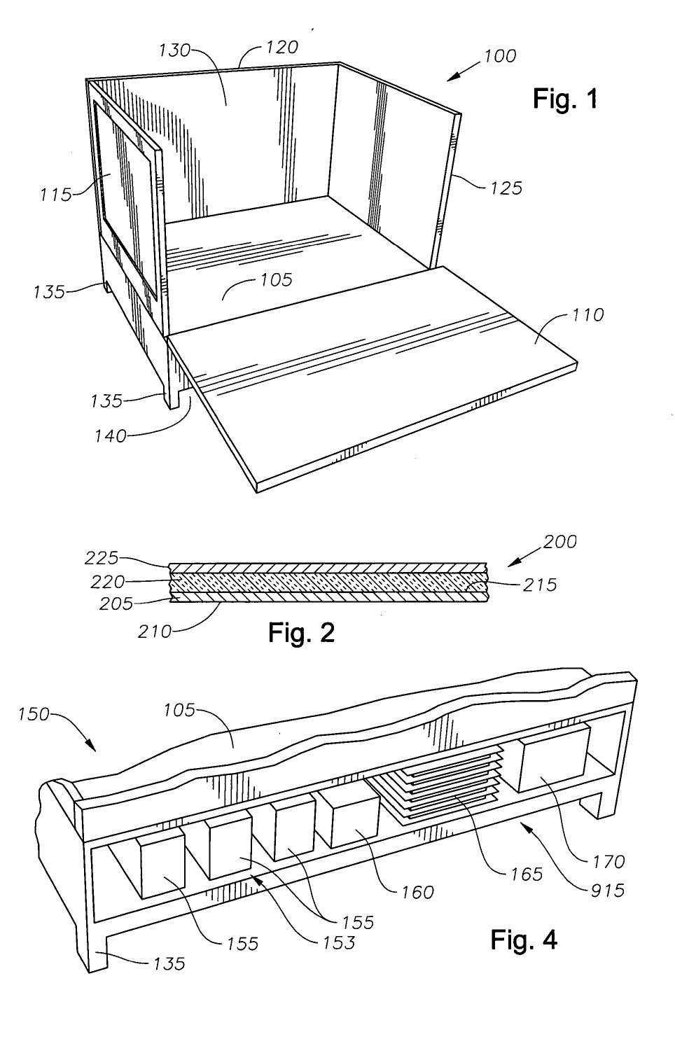

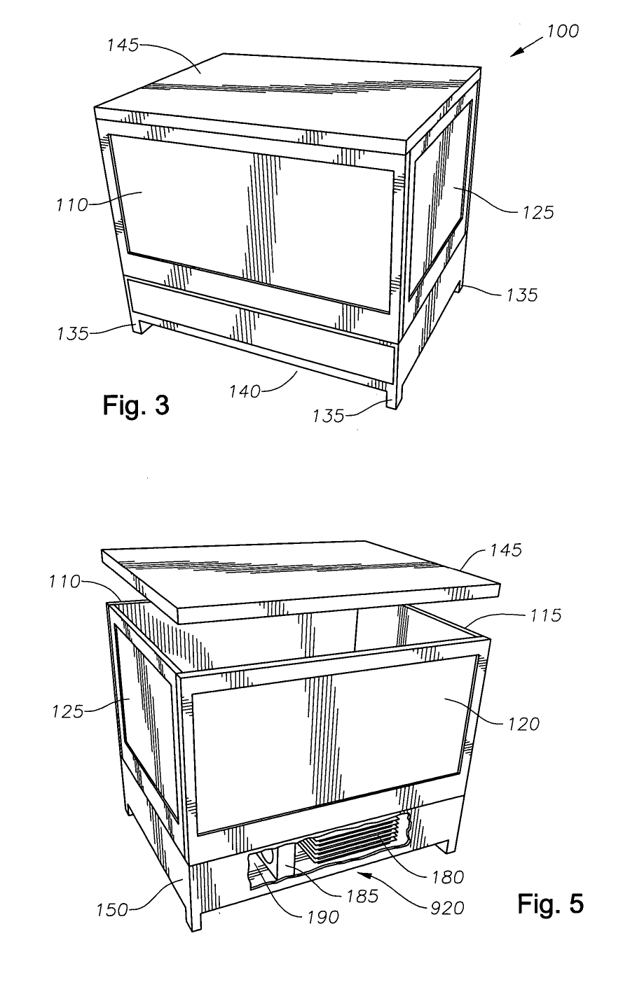

FIGS. 1-5 show one embodiment of the temperature-controlled container 100 of the present invention. It includes a bottom 105, four sides 110, 115, 120, 125, and a top 145 (shown in FIG. 3), defining a cargo space 130. Side 110 is shown in an open position in FIG. 1 to allow easy access to the cargo space 130. To achieve high thermal efficiency, space efficiency, and long operating times on internal batteries, the container is insulated with high R value vacuum panels.

FIG. 2 shows one embodiment of a side 200, which is the preferred structure of sides 110, 115, 120, 125 and top 145. A wall 205 of side 200 has an outside surface 210 and an inside surface 215. Inside surface 215 is preferably covered with an insulated vacuum panel 220. The insulated vacuum panel preferably has an R value per inch of at least about 20. More specifically, the insulated vacuum panels have an R value per inch of preferably around about 45. Examples of suitable insulated vacuum panels are described in U.S. Pat. Nos. 5,943,876, 5,950,450, and 6,192,703, the contents of which are incorporated herein by reference to the extent necessary to describe their insulated vacuum panels. Other insulated vacuum panels having an R value per inch of at least about 20 can be used.

The surface of the insulated vacuum panels 220 is covered with a protective sheet 225 to protect the insulated vacuum panels from damage during use. The protective sheet 225 could be a sheet of hard plastic, metal, or other hard material. Typically, all four sides 110, 115, 120, 125, and top 145, would be made of walls having the structure shown FIG. 2. Alternatively, one or more walls could have different structures.

In the preferred embodiment, container 100 also has four legs 135 projecting downward from bottom 105 at the corners of bottom 105. There is an opening 140 between the legs 135 so that the forks of a forklift truck can be placed under the container 100 to move it. There is a corresponding opening between the legs on the opposite side of the container. As desired, there can also be additional legs between the legs at the corner, for example at the midpoint of a side.

FIG. 3 shows container 100 with side 110 in an upright position and top 145 in place. Top 145 can be completely removable (as shown in FIG. 1) to provide access to the cargo space. Alternatively, the top 145 could be connected to one the sides with a hinge or other connector.

A housing 150 is located between legs 135 below side 110. Housing 150 contains a temperature regulating unit 915, temperature controller 900, and a power supply 153. Housing 150 can be located between any two of legs 135.

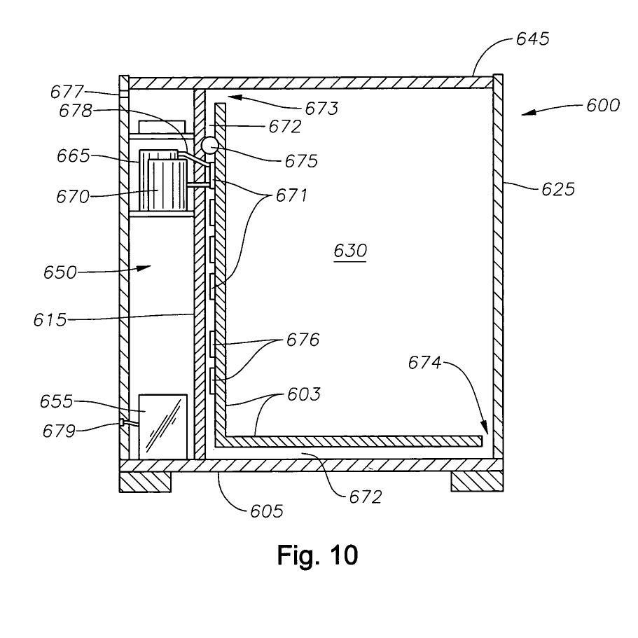

FIG. 4 shows the inside of housing 150. In this embodiment, power supply 153 includes three (3) batteries 155. The use of internal batteries 155 allows the temperature of the cargo to be maintained for several days without the use of external power. Any suitable battery can be used. For example, deep cycle 12 volt lead-acid batteries are suitable because of their ready availability and low cost. Additionally, higher cost alkaline batteries are suitable because they have a longer life and are also a good choice. Housing 150 also includes a battery charger 160 when batteries 155 are power source 153, to recharge batteries 155 with either an external AC source or an external DC source 679 (FIG. 9). An AC to DC converter 680 (FIG. 9) can be included to allow the refrigeration unit and heating unit to be operated from an external AC source. Power supply 153 can alternatively be an AC source or a DC source, and it can be internal or external. An external DC source can be provided from the transport unit, such as the truck, rail car, ship, or aircraft. Solar cells can be used as well as conventional DC sources.

For refrigeration, temperature regulating unit 915 typically includes a vapor compression unit. One embodiment includes condenser 165 and compressor 170. For compressor 170, DC powered rotary compressors, or AC powered rotary compressors and linear compressors can be used. Other examples of suitable compressor 170 could also be used as is well known in the art. As shown in FIG. 5, container 100 preferably also includes a heat unit 920 with a heat exchanger evaporator/heater 180 and a fan 185 that are placed in a compartment 190 underneath bottom 105. In the preferred embodiment, compartment 190 contains conventional polystyrene foam insulation.

Walls 110, 115, 120, 115 of container 100 can be fixedly connected to bottom 105 so as to be in a fixed substantially upright position, or collapsible to allow for reduced volume returned shipping. Collapsible containers are described in U.S. Pat. No. 6,237,361, the contents of which are incorporated herein by reference to the extent necessary to describe their collapsible containers. Container 100 can be made of an extruded aluminum frame with welded aluminum sides 110, 115, 120, 125, bottom 105 and top 145. Alternatively, the container can be made of another suitable metal or a durable, high impact reinforced plastic.

In the preferred embodiment, container 100 of the embodiment of FIGS. 1-5 is designed to accommodate a standard 40 inch by 48 inch pallet (although it could be larger or smaller if desired). With such dimensions, container 100 advantageously provides a usable internal cargo space of at least about 30 cubic feet or more. Typical increases in usable cargo space are incremental and include, but are not limited to, more than about 40 cubic feet, more than about 50 cubic feet, and more than about 60 cubic feet.

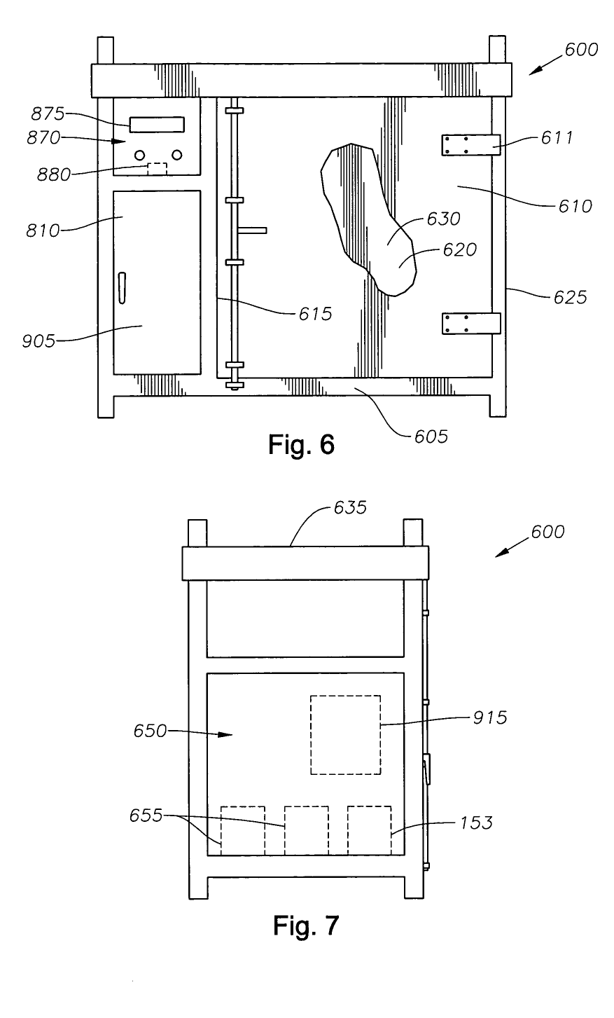

FIGS. 6 and 7 show an alternative embodiment of the present invention. An alternative container 600 has a bottom 605, sides 610, 615, 620, 625 defining a cargo space 630. Side 610 and a plurality of hinges 611 define a door, which opens for access to the cargo space 630. The sides and top generally include insulated vacuum panels as described above. In the embodiment shown in FIGS. 6 and 7, a housing 650 is located adjacent one of side 615 rather than below bottom 605. Like the embodiment shown in FIGS. 1-5, housing 650 includes batteries 655 and refrigeration units 915. As will be readily appreciated by those skilled in the art, container 600 can also include a compartment 190 (not shown) for housing heat exchangers and fans 180, 185 (not shown in FIGS. 6 and 7).

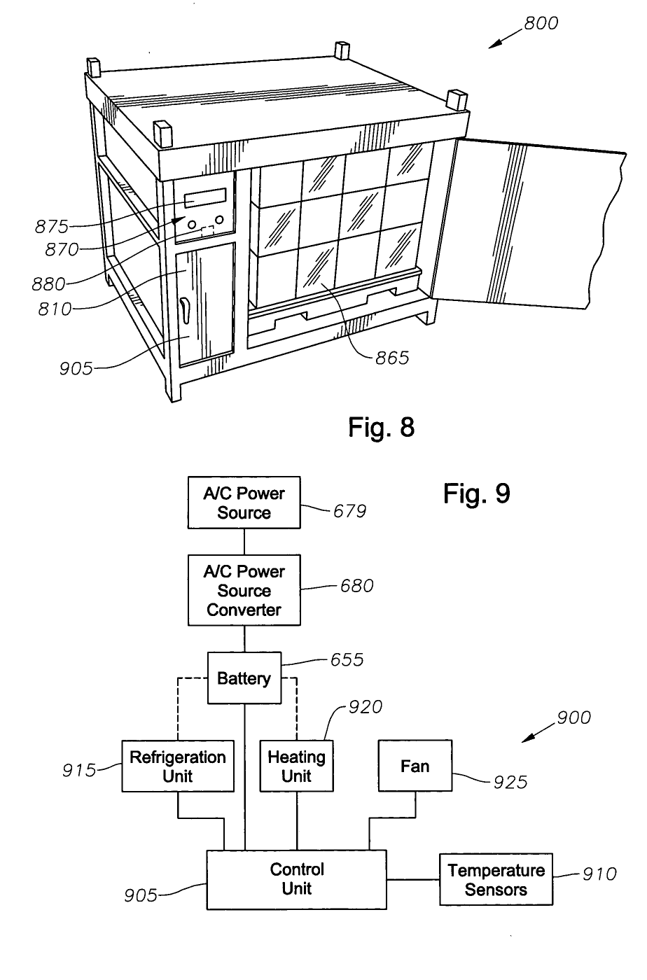

As shown in FIG. 8, in an alternative container 800, the frame of container 800 includes substantially the same structural features as the embodiment shown in FIGS. 6-7. Container 800 can also include sub-containers 865. Sub-containers 865 can be insulated and/or use phase change materials or other materials to hold temperatures for several hours after being broken out the container 800 for short-term delivery of the cargo to its destination. Sub-containers 865 can be either rigid or collapsible. The exterior of sub-containers 865 can be made of a heat conducting material, such as aluminum, to assist in keeping the temperature experienced by the cargo uniform.

Container 800 preferably includes a temperature control unit 905 having a temperature control panel 870. Temperature control panel 870 allows a temperature set point to be entered. It also includes a display 875 which allows monitoring of the temperature in the cargo space. Temperature control panel 870 also includes terminal space 880 for extra features that may be desired by operators in various situations. For example, terminal space 880 receive a global positioning satellite (GPS) receiver, a wireless telephone such as a satellite or cell telephone, and a modem. Such a wireless phone can be used to report the location of the cargo, the cargo temperature, and other data while the container is in transit or stationary. Alternatively, terminal space 880 can also house a computer port to allow the temperature history to be downloaded to a computer, such as a personal computer or a personal digital assistant. Suitable computer ports include, but are not limited to, infrared ports and USB ports.

Referring to FIG. 10, a cross section of the embodiments shown in FIGS. 6-8 shows how the cooled and heated air is communicated with the cargo space. In container 600 or 800, side 615 defines a partition to divide cargo space 630 from housing 650. An annulus 672 is partially defined between side 615 and a side and lower plenum 603. The remainder of annulus 672 is defined beneath plenum 603 and floor 605. In the preferred embodiment, an opening 673 is located between the upper edge of plenum 603 and the top 645. Another opening 674 is preferably located between side 625 and plenum 603. An electrical fan 675 is preferably located within annulus 672. Fan 675 circulates air from annulus 672 into cargo space 630 through opening 673, while drawing air from cargo space 630 into annulus 672 through opening 674.

For cooling, batteries 655 power compressor 670. Compressor 670 is in fluid communication with coils 671 that are also located within annulus 672. Compressor 670 is also in fluid communication with condenser 665 located with housing 650. Compressor 670, condenser 665, and coils 671 are in fluid communication with each other through fluid lines 678 that sealingly extend through side 615. Coils 671 receive a liquid refrigerant from condenser 665. Fan 175 draws air across coils 671, where heat is exchanged between the air and the refrigerant in a manner known in the art. Fan 675 blows the cooled air into cargo space 630 through opening 673. The cooled air enters cargo space 630 and cools any temperature-sensitive cargo. Fan 675 also creates a suction, or low pressure zone, within the portion of annulus 672 below coils 671. The low pressure zone creates a suction that draws air from cargo space 630 into annulus 672 through opening 674.

The liquid refrigerant heats and evaporates into a gaseous state while the air in annulus 672 passes over coils 671. The gaseous refrigerant flows to compressor 670. The differential pressure created by compressor 670 draws the gaseous refrigerant from coils 671, and forces the gaseous refrigerant into condenser 665. The air within housing 650 cools the refrigerant, which causes the refrigerant to liquefy. The liquefied refrigerant then flows back to coils 671 from condenser 665. The air cooling the refrigerant within condenser 665 vents out of a plurality of air vents 677 of container 600 located beneath top 645. Another electrical fan (not shown in FIG. 10) can also be located within housing 650 for blowing air over condenser 665.

For heating, batteries 655 power a heating coil 676 that is also located with annulus 672. In the embodiment shown in FIG. 10, heating coil 676 is a resistance coil that generates heat due to the resistance of the material coil 676 as electric current flows through coil 676. Fan 675 circulates air in the same manner described above to heat the contents of cargo space 630. Temperature control unit 905 controls whether heating unit, which includes heating coil 676, or refrigeration unit 915, which includes compressor 670, receives electricity from batteries 655 based upon temperature values from temperatures 910 and the inputted temperature from the operator. As will be appreciated by those skilled in the art, a similar arrangement is easily implemented for the embodiment shown in FIGS. 1-5, wherein housing 150 and compartment 190 houses the refrigeration, heating and power systems below the cargo space rather than in housing 650 beside cargo space 630.

In operation, fan forced air is driven through ductwork over the heat exchanger type evaporator and heater to the cargo space through a supply air opening in the top of the side wall and through a return air opening at the bottom of the opposing side wall from which it returns through the hollow compartment underneath the bottom. Controlling the run cycle of the compressors or heaters, and the fans controls the temperature in the cargo space, which may be set to refrigeration, freezing, or heating conditions.

The refrigeration unit or heating unit can include a thermal storage phase change material (PCM) over which the refrigerated or heated air is driven. An example of a PCM is the refrigerant in the refrigeration system described above. The use of PCM allows the operating time at the proper temperature to be extended when the container is in an unpowered state. For a refrigeration unit, the PCM would normally be in a liquid state when the unit is first turned on. As the unit operates and refrigerated air is driven over the PCM storage unit, the PCM becomes fully frozen. At this point, the temperature controller may turn off the compressor and maintain the cargo temperature with the use of only fan forced air driven past the PCM. The PCM can be incorporated into the refrigeration unit in various ways, including but not limited to, using a standard fin heat exchanger with coils filled with PCM. Many other configurations are possible and are well known in the art. Alternatively, the PCM can reside in individual containers in the cargo space. Suitable PCMs are described in U.S. Pat. Nos. 5,943,876, 5,950,450, and 6,192,703, the contents of which are incorporated herein by reference to the extent necessary to describe the PCMs. The temperature of the container of the present invention can be maintained over a wide temperature range above and below freezing. The container includes a heating unit to maintain cargo space temperature when the ambient temperature is below the desired cargo temperature.

Referring to FIG. 9, internal cargo temperature is maintained with a temperature controller 900. FIG. 9 shows a schematic of the temperature controller 900. The temperature controller 900 includes a temperature control unit 905 with control circuitry that monitors the temperature in the cargo space with one or more temperature sensors 910 and directs power to the refrigeration unit 915, heating unit 920, or fan 925, as appropriate. Control unit selectively controls the flow of power from battery 655 to either refrigeration unit 915 or heating unit 920 depending on whether the cargo space within the container needs to be heated or cooled in order to obtain an inputed temperature value. AC power source 679 can be used to recharge batteries 655. When power source 679 is an AC power source, an AC power source converter 680 advantageously converts the current for storage in battery 655. Power source 679 can also be a DC power source, in which case AC converter 680 is not necessary. As shown in FIG. 10, power source is preferably positioned on an outer surface of compartment 650 for recharging batteries 655 inside of compartment 650.

The temperature control unit can include a control panel that allows an operator to input the desired temperature set point. It can also include a display, including but not limited to a digital display, which allows visual monitoring of the cargo temperature. It can optionally include a temperature recorder which stores the temperature history of the cargo during transit.

The cargo type and other specifications can be identified through well known systems, including but not limited to, bar coding and RFID (Radio Frequency Identification) tags.

The temperature regulating units, temperature controller, and power supply can be contained in detachable modules connected to the container.

The exterior of the container can be painted with reflective paint to improve the thermal efficiency in direct sunlight.

The containers of the present invention can be loaded with other shipping containers in a conventional refrigerated trailer to reduce the cargo-to-ambient temperature difference. This reduces the battery consumption of the containers during a long haul. Individual containers can then be broken out for shorter haul delivery or short term warehousing or staging before delivery of the cargo to its final destination. The use of several containers of the present invention in a refrigerated trailer allows the use of different control temperature set points for each container.

The complete climate requirements for any cargo can be met with the containers of the present invention. In addition to temperature control, humidity, gas atmosphere (for example nitrogen or carbon dioxide), and lighting can be controlled.

The temperature-controlled, pallet-sized shipping containers of the present invention have a number of advantages: temperature-sensitive cargo can be shipped by individual pallet, refrigerated cargo can be consolidated thereby reducing or eliminating the need for dedicated refrigerated units, and individual containers can be off-loaded and reloaded at multiple delivery points. A further advantage is that the shipping temperatures can be set and maintained for each container according to its specific contents to achieve optimum freshness and reduce or eliminate spoilage. This allows shipping any mix of cargos on the same freight trailer. A further advantage is that the exact location and temperature histories of each pallet can be downloaded through GPS and other methods. Yet another advantage is that positioning the insulated vacuum panels on the inside wall(s) of the container helps to minimize the occurrence of a short circuit in the temperature control unit. Other advantages of the invention should be apparent to those of skill in the art.

While certain representative embodiments and details have been shown for purposes of illustrating the invention, it will be apparent to those skilled in the art that various changes in the compositions and methods disclosed herein may be made without departing from the scope of the invention, which is defined in the appended claims.

What is claimed is:

1. A portable, temperature-controlled container for storing and transporting temperature-sensitive materials, comprising:
a container having a bottom wall, four side walls, and a top wall defining a cargo space;
a electrical temperature regulating unit connected to the container, the temperature regulating unit comprising a refrigeration and heating unit, the temperature regulating unit being in communication with the cargo space of the container;
a temperature controller connected to the container, the temperature controller comprising a temperature control unit and a temperature sensor positioned in the cargo space of the container; and
a power supply.

2. The portable, temperature-controlled container of claim 1, wherein the walls comprise insulated vacuum panels.

3. The portable, temperature-controlled container of claim 1, wherein the insulated vacuum panels have an R value per inch of at least about 20.

4. The portable, temperature-controlled container of claim 1, wherein the power supply is an AC source.

5. The portable, temperature-controlled container of claim 4, wherein the AC source is external to the cargo space.

6. The portable, temperature-controlled container of claim 1, wherein the power supply is a DC source.

7. The portable, temperature-controlled container of claim 6, wherein the DC source is external to the cargo space.

8. The portable, temperature-controlled container of claim 1, further comprising an AC to DC converter.

9. The portable, temperature-controlled container of claim 1, wherein the temperature regulating unit further comprises a fan.

10. The portable, temperature-controlled container of claim 1, wherein the refrigeration unit is a vapor compression refrigeration unit.

11. The portable, temperature-controlled container of claim 10, wherein the vapor compression unit comprises a DC powered rotary compressor.

12. The portable, temperature-controlled container of claim 1, wherein the refrigeration unit includes a fin heat exchanger having coils filled with a thermal storage phase change material.

13. The portable, temperature-controlled container of claim 1, further comprising a computer port for downloading information to a computer.

14. The portable, temperature-controlled container of claim 1, wherein the computer port is selected from an infrared computer port, and a USB port.

15. The portable, temperature-controlled container of claim 1, further comprising a global positioning satellite receiver.

16. The portable, temperature controlled container of claim 1, further comprising a wireless telephone and modem.

17. The portable, temperature-controlled container of claim 1, wherein at least one side may be opened for access to the cargo space.

18. The portable, temperature-controlled container of claim 1, wherein the top is removable.

19. The portable, temperature-controlled container of claim 1, wherein at least four feet project downward from the bottom of the container, the feet defining an opening therebetween so that the forks of a forklift may be inserted into the opening.

20. The portable, temperature-controlled container of claim 1, wherein the container is collapsible wherein the four side walls fold over the bottom wall.

21. The portable, temperature-controlled container of claim 1, wherein the cargo space is at least 30 cubic feet.

22. A portable, temperature-controlled container for storing and transporting temperature-sensitive materials, comprising:
a container having cargo space defined by a bottom wall, four side walls, and a top wall, the container also having a compartment separate and insulated from the cargo space and being separated by one of said four side walls;
an electrical temperature regulating unit connected to the container and which is in communication with the cargo space of the container, the temperature regulating unit comprising a refrigeration assembly, the temperature regulating unit comprising an electric compressor and a condenser positioned within the compartment, and a refrigeration coil located within the cargo space that is in fluid communication with the compressor and condenser for the air within the cargo space;
a temperature controller connected to the container, the temperature controller comprising a temperature control unit and a temperature sensor positioned in the cargo space of the container; and
a power supply.

23. The portable, temperature-controlled container of claim 22, wherein the temperature regulating unit further comprises a fan located within the cargo space for circulating air over the refrigeration coil.

24. The portable, temperature-controlled container of claim 22, wherein the temperature regulating unit further comprises a heating unit comprising an electric heating coil having located within the cargo space and is in electrical communication with the power supply.

25. The portable, temperature-controlled container of claim 24, wherein the temperature regulating unit further comprises a fan located within the cargo space for circulating air over the refrigeration coil and the heating coil.

26. The portable, temperature-controlled container of claim 25, wherein the temperature control unit controls the electrical current between the electrical compressor and the electric heating coil for selectively heating or cooling the interior of the cargo space.

27. The portable, temperature-controlled container of claim 25, wherein insulation panels positioned adjacent the bottom wall and the side wall separating the compartment from the cargo space define an annulus, the annulus being in fluid communication with the cargo through an at least a pair of openings; and
wherein the fan, the refrigeration coil, and the heating coil are positioned in the annulus between the openings so that the fan draws air from the cargo space through one of the openings over the heating and refrigeration coils and then blows the air into the into the cargo space through the other opening.

28. The portable, temperature-controlled container of claim 22, further comprising a plurality of legs extending from the bottom wall that define a space adapted to receive a set of tines of a forklift.

29. The portable, temperature-controlled container of claim 22, further comprising a plurality of spacer supports extending from the top wall defining a space above the top wall for receiving a set of tines of a forklift when another container is placed on top of the portable, temperature controlled container.
